(19) United States
(12) Patent Application Publication
(10) Pub. No.: US 2002/0102991 A1
(43) Pub. Date: Aug. 1, 2002

(54) Superagile high gain earth coverage communication system

(76) Inventor: Donald R. Sentz, Beverly Hills, CA (US)

Correspondence Address: Michael S. Yatsko, TRW Inc., Law Dept., One Space Park, Bldg. E2/6051, Redondo Beach, CA, 90245, US

(21) Appl. No.: 09/771,474

(22) Filed: Jan. 26, 2001

(51) Int. Cl. H04Q 7/20

(52) U.S. Cl. 455/456; 455/562

(57) ABSTRACT

A method (400) for providing communication bandwidth with a communication satellite includes reading (404) communication target positions from a position memory and electronically steering (406) an antenna in accordance with the target positions to provide bandwidth to the communication target. In addition, the method receives (408) updated communication target positions in an uplink and responsively updates (410) the communication target positions in the memory. Thus, each communication target independently exercises control over the pointing of the beam spot assigned to that communication target. The beam spot may be narrow (e.g., between 0.9 and 3.5 degrees in angular diameter) and thus provide high gain. A predetermined access schedule (e.g., a fixed length time division multiplexed frame) may be enforced to provide communication access for each communication target.

This invention was made with Government support under Contract No. F04701-99-C-0027 awarded by the US Air Force. The Government has certain rights in this invention.

### BACKGROUND OF THE INVENTION

The present invention relates to satellite communication systems. In particular, the present invention relates to a satellite communication system that employs highly agile spot beams to provide bandwidth for terrestrial communication targets.

Satellites have long provided communication bandwidth on a global scale. Time division multiple access (TDMA) uplinks, and time division multiplexed (TDM) downlinks provide, in conjunction with Frequency Division Multiplexing (FDM), the signal structure that carries information to the satellite and from the satellite. In the past, satellites projected downlinks and received uplinks as High Gain Earth Coverage (HGEC) beam spots (3.5 degrees or more in angular diameter) covering fixed terrestrial cells or other localized areas. Prior satellites also provided Low Gain Earth Coverage (LGEC) antennas that provided communication bandwidth at a far lower data rate over a much larger area than a single cell.

The energy in even a relatively narrow 3.5 degree beam spot is distributed over a large area. The distribution of energy, while providing much higher gain than an LGEC antenna, nevertheless imposes a significant bandwidth limitation on the uplink and downlink. Thus, in the past, the beam spots provided throughput on the order of 75 to 2.4 kbps. As the number of communication targets increases, and as those communication targets disperse geographically, the cost and complexity required to support the communication targets increase dramatically (and may be quite wasteful, if, for example, an entire beam spot is required for a single remote communication target).

The inevitable and steady increase in bandwidth demand and the number of communication targets to be supported quickly outstrips the bandwidth capability of prior communication satellites. While it may be possible to provide additional HGEC antennas during satellite design and construction in anticipation of increased bandwidth demand, doing so greatly increases the cost, complexity, and weight of the resultant satellite.

A need has long existed in the industry for a high gain Earth coverage communication system that addresses the problems noted above and others previously experienced.

### BRIEF SUMMARY OF THE INVENTION

A preferred embodiment of the present invention provides a method for providing communication bandwidth with a communication satellite. The method includes reading communication target positions from a position memory and electronically steering an antenna in accordance with the target positions to provide bandwidth for the communication target. The antenna may be a phased array uplink or downlink antenna, for example. In addition, the method receives updated communication target positions in an uplink and responsively updates the communication target positions in the memory. Thus, each communication target independently exercises control over the pointing of the beam spot assigned to that communication target.

Because the beam spot is typically assigned to a single communication target, the beam spot may be narrower (e.g., between 0.9 and 3.5 degrees in angular diameter) and provide commensurately higher gain. In turn, the communication target may transmit (or receive) at a higher instantaneous burst bit rate, and thus a predetermined access schedule may support an increased number of communication targets. When the access schedule is a fixed length time division multiplexed frame, for example, the frame may include additional time slots individually assigned to communication targets over that available in prior systems.

Another preferred embodiment of the present invention provides a communication path processing system for a communication satellite. The processing system includes an electronically steered antenna, a position memory for storing communication target positions, and a processor coupled to the position memory. The processor is operable to track communication targets by updating the communication target positions based on updated communication target positions received in an uplink. To that end, an antenna controller coupled to the antenna and to the processor steers the antenna in accordance with the target positions to provide bandwidth to the communication targets as they move.

In other words, the antenna generates beam spots assigned to individual communication targets. The communication targets may then individually exercise control over their assigned beam spots by generating the updated communication target positions. As noted above, the antenna may be an uplink or downlink phased array antenna, operating in accordance with a predetermined access schedule.

### BRIEF DESCRIPTION OF THE DRAWINGS

FIG. 1 illustrates a communication path processing system for an uplink.

FIG. 2 shows a communication path processing system for a downlink.

FIG. 3 shows a synchronization hop distribution.

FIG. 4 shows a method for providing communication bandwidth with a satellite.

FIG. 5 illustrates a four channel steerable uplink communication path.

### DETAILED DESCRIPTION OF THE INVENTION

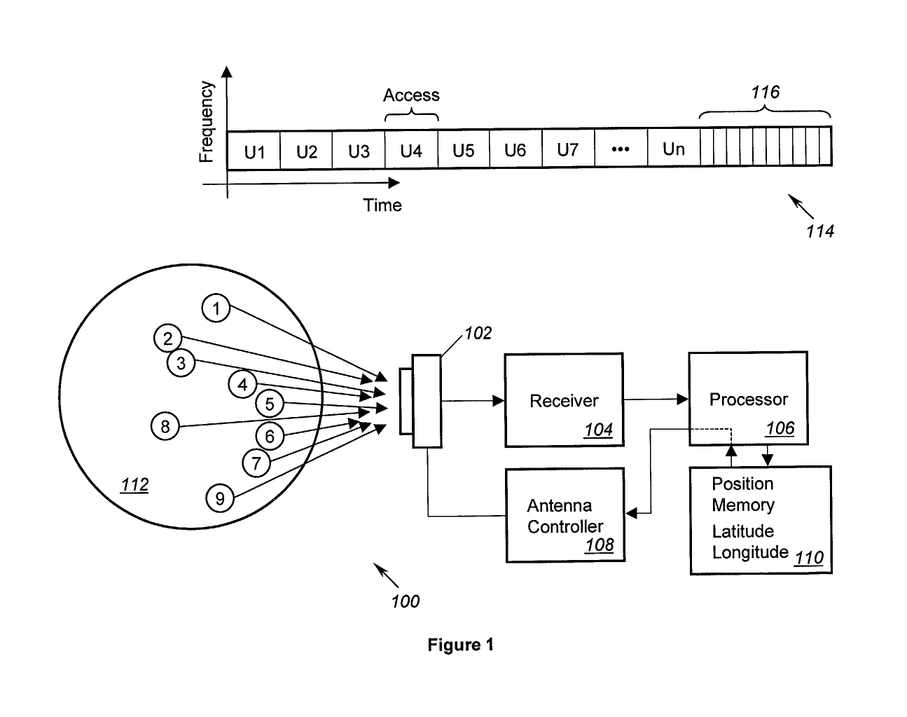

Turning now to FIG. 1, that figure illustrates a communication path processing system 100 for a communication satellite uplink. The processing system 100 includes an electronically steered uplink antenna 102 (e.g., a phased array antenna), a receiver 104, and a processor 106. The processing system 100 further includes an antenna controller 108 and a position memory 110 coupled to the processor 106. The processing system 100 provides bandwidth for communication targets (e.g., those numbered 1-9 in FIG. 1) in an Earth field of view 112.

In addition, FIG. 1 presents a predetermined access schedule 114. The schedule 114, as shown, is a time division multiple access frame that provides one or more time slots (e.g., labeled U1-Un) for each communication target 1-9. The schedule 114 may include additional time slots for future expansion. Furthermore, the schedule 114 provides overhead access slots, collectively labeled 116, for the time slots U1-Un, as well as an additional access slot for general system overhead. Note that additional uplink antennas may support additional time division uplinks separated in frequency.

In operation, the antenna controller 108 steers the uplink antenna 102 according to communication target positions stored in the position memory 110. The communication target positions may be arranged in an ordered list, thereby determining the steering sequence of the uplink antenna 102. As an example, as time slot U2 begins, the antenna controller 108 steers the uplink antenna 102 to point to communication target 2. The processor 106 preferably reads the communication target positions from the position memory 110. The communication target positions may be uplinked from the communication targets in GPS latitude and longitude, for example.

The processor 106 than applies a coordinate transform to correct for pointing errors and satellite ephemeris, and outputs azimuth and elevation to the antenna controller 108. The antenna controller 108 determines the phase and amplitude settings for each radiating element in the uplink antenna 102, and further applies temperature and voltage corrections to ensure proper pointing of the uplink antenna 102.

Preferably, the uplink antenna 102 provides a narrow beam spot that covers each communication target individually. To that end, the uplink antenna 102 may, using established phased array focusing techniques, generate beam spots less than 3.5 degrees in angular diameter, and preferably approximately 0.9-1.0 degrees in angular diameter. The narrow beam spots provide high gain, and allow higher burst bit rate communication. Thus, the time slots for a fixed data rate may be reduced in time duration, and additional communication targets may be supported, as compared to legacy systems. More efficient support for highly dispersed users results.

Note also that each communication target is generally assigned a beam spot. Thus, the communication target may exercise independent control over pointing for its beam spot by uplinking updated communication target positions to the processing system 100. For example, the updated communication target positions allow the processing system 100 to track each communication target as it moves. Thus, communication targets such as aircraft, submarines, ships, and the like have dedicated beam spots that follow as the communication target moves.

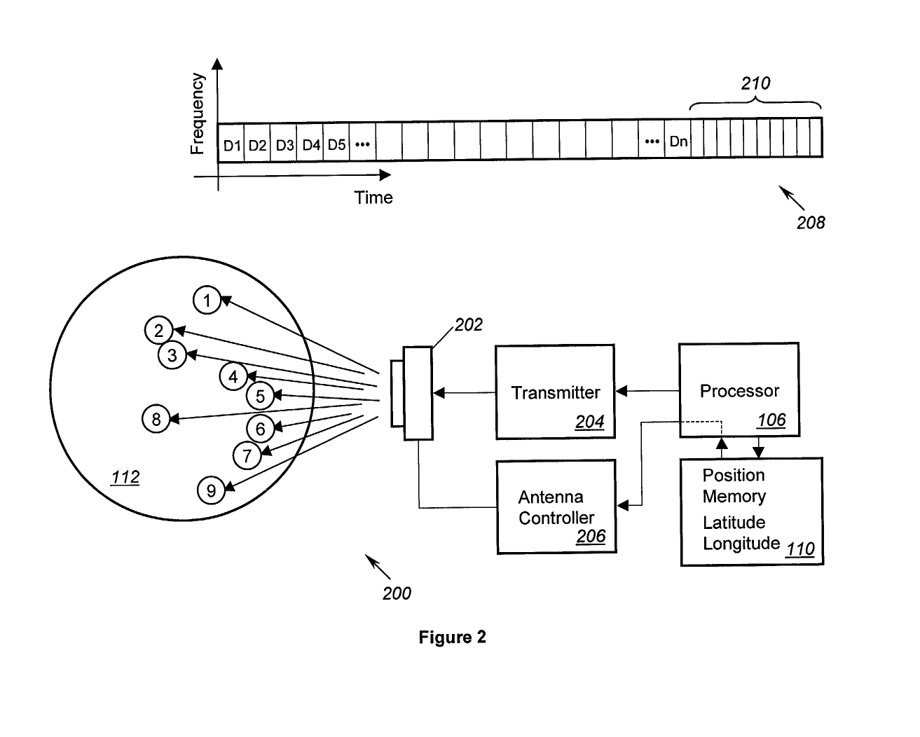

The downlink may be provided for in a corresponding manner. In FIG. 2, a processing system 200 for a communication satellite downlink is illustrated. The processing system 200 includes an electronically steerable downlink antenna 202 (e.g., a phased array antenna), a transmitter 204, and an antenna controller 206. The processor 106 and position memory 110 are also present, and provide downlink bandwidth according to the time division multiplexed access schedule 208, including downlink slots D1-Dn, and synchronization slots 210.

Because the position memory 110 stores the location of each communication target 1-9, the antenna controller 206 may responsively steer the downlink antenna 202 to provide bandwidth according to the access schedule 208. Thus, the downlink also follows each communication target 1-9 as it moves. In other words, each communication target 1-9 operates with its own dedicated cell.

As examples, the uplink access schedule 114 may be 20 ms long, and divided into between 100 and 400 slots per frame. Each slot is then between 50 and 200 microseconds in duration. The overhead accesses 116 are each preferably 1 to 8 slots in duration. The downlink access schedule 208 may also be 20 ms long, and likewise divided into between 100 and 400 slots per frame.

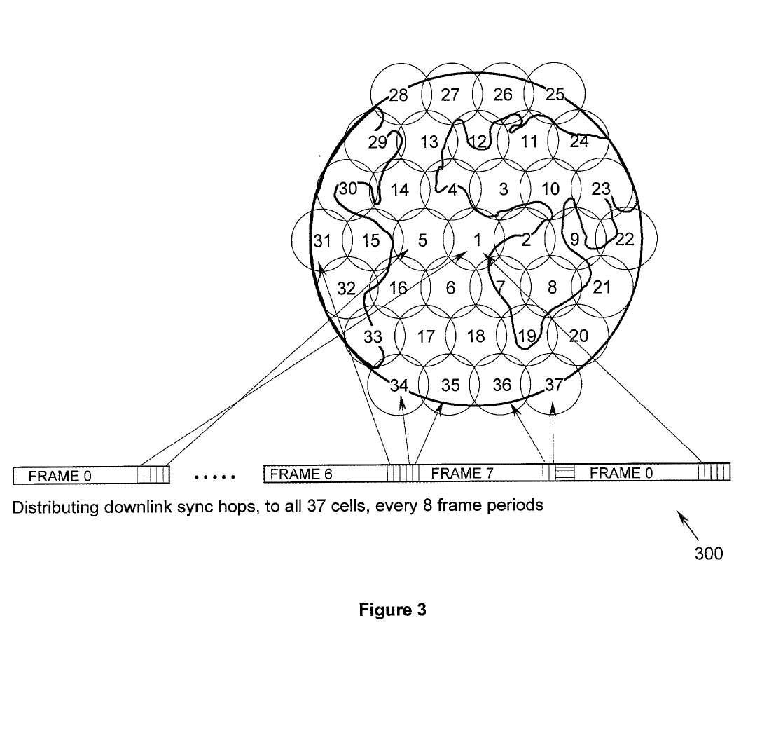

Turning next to FIG. 3, that figure illustrates an exemplary beam spot pattern 300 for providing initial time acquisition and synchronization for new communication targets. In FIG. 3, beam spots numbered 1-37 provide coverage for the Earth field of view. The beam spots 1-37 are generally fixed in location. When a communication target desires access to the communication satellite, it is generally aware of its local time, location, and the direction to point to the satellite. The communication target then monitors the satellite downlink frequency for synchronization hops.

Note that the beam spots 1-37 may be generated with the phased array uplink and downlink antennas 102, 202. To that end, the antenna controllers 108, 206 may use established phased array focusing techniques to generate approximately 3.5 degree beam spots, instead of the narrower 0.9-1.0 degree beam spots that cover the communication targets specifically. The beam spots 1-37 are assigned fixed latitude and longitude positions in the position memory 110. The processing systems 100, 200 thereby support both mobile narrow beam spots for the communication targets and wider fixed beam spots for acquisition purposes.

The synchronization hops provide a bit pattern formed preferably as a pseudo-random pattern of 1s and 0s having no significant auto-correlation for offsets greater than 1 chip period. The strength of the received signal allows the communication target to determine which beam spot best serves the current location of the communication target. The communication target then tunes its local clock for best reception of the synchronization hop. Preferably, as shown in FIG. 3, the synchronization hops are transmitted using a fixed transmission schedule that maps the synchronization hops to beam spots. The transmission schedule may rely upon one or more predetermined overhead accesses in a frame for this purpose (e.g., the frames 0-7 shown in FIG. 3).

Once the communication target synchronizes to the synchronization hop, the communication target may receive and process an orderwire message access. The orderwire message access is generated by and transmitted from the satellite and includes information that indicates which uplink time probe accesses are presently available for use. An uplink time probe access is defined as a set of slots within one or more frames, with several such consecutive accesses comprising a probe block. The orderwire messages are also transmitted to each cell on a fixed schedule matched to the steering of the uplink antenna 102. One orderwire message reports on all probe accesses in a probe block.

Once the communication target has acquired the downlink signal and processed the orderwire message from the satellite, the communication target may select an available uplink probe acess for its beam spot. The communication target proceeds to transmit an uplink acquisition probe signal during the time interval associated with the selected probe access.

A satellite receiver (as it switches or steers from beam spot to beam spot) detects the uplink acquisition probe signal, and transmits timing correction information to the communication target in a downlink. A predetermined log-in message generally follows from the communication target to the satellite, and the satellite responds by granting a message access and time probe access dedicated to the communication target.

A communication target may next send a request for a specific type of service. For example, the communication target may request service in a fixed location spot beam, a fixed location time-shared spot beam, or in a mobile, dedicated spot beam, as described above. Included in the request are GPS latitude and longitude coordinates for the satellite to use in steering the uplink antenna 102 and downlink antenna 202. Assuming the communication target selects mobile (or “superagile”) beam spot coverage, the satellite assigns a time access (e.g., one of the time accesses U1-Un for the uplink and D1-Dn for the downlink, and also assigns a new uplink probe access used for an ongoing time-tracking function.

Mobile communication targets generally uplink updated communication target positions to the satellite. An updated communication target position generally includes a new GPS latitude and longitude for the communication target, although other coordinate systems may also be employed. In other words, each communication target has control of a steerable spot beam during exclusive uplink and downlink accesses within the time structure of that spot beam.

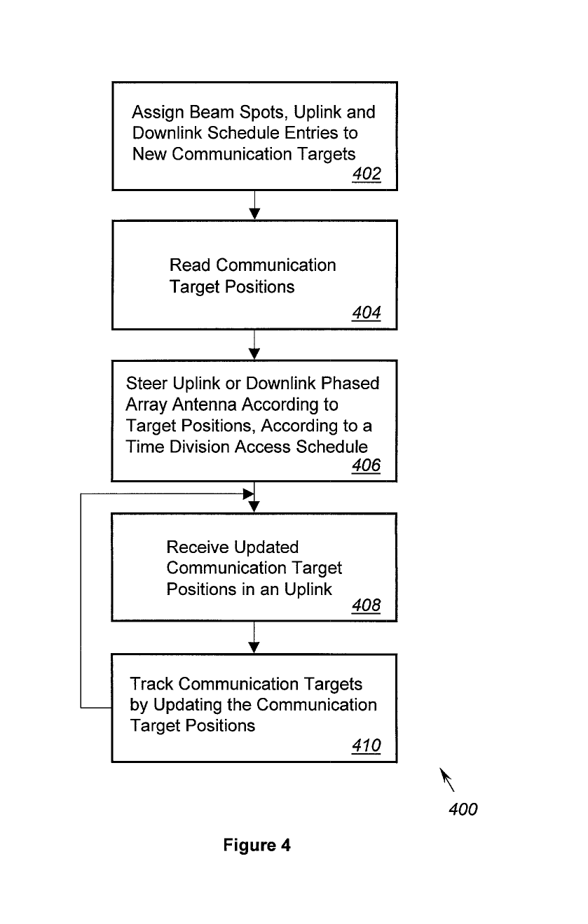

Turning next to FIG. 4, that figure illustrates a high level flow diagram 400 of a method for providing communication bandwidth with a satellite. The method first assigns (402) beam spots, uplink access schedule entries (e.g., one to several time slots per access), and downlink access schedule entries to communication targets. The method then reads (404) communication target positions (e.g., from the position memory 110). Next, the method steers (406) an uplink or downlink phased array antenna 102, 202 according to the communication target positions. As noted above, the steering generally occurs in accordance with a predetermined access schedule, such as a time division multiplexed frame.

Next, the method receives (408) updated communication target positions in an uplink. The method may then track (410) communication targets by updating the communication target positions in the position memory (110). Each communication target thereby exercises independent control over its assigned spot beam, which may then travel with the communication target itself. Alternatively, the spot beam may be redirected by the communication target to a different entity temporarily for a predetermined time (for example, one time slot) or until commanded back to the original communication target.

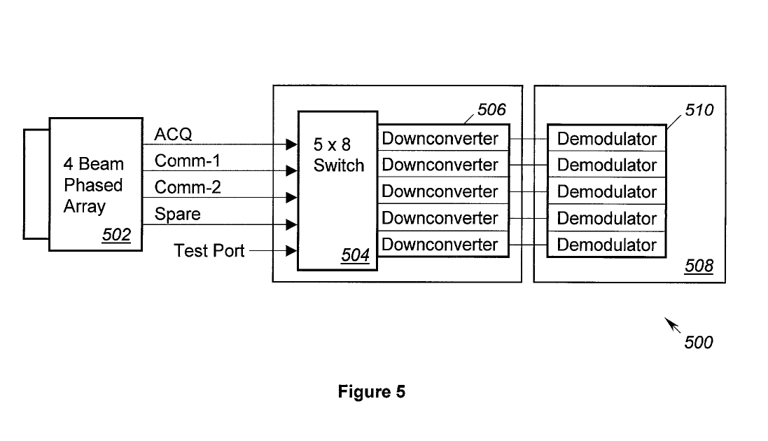

FIG. 5 illustrates a second example of a communication path processing system 500. The processing system 500 includes a four beam phased array 502, a switch 504, and downconverters (e.g., the downconverter 506) shown connected to five of the eight switch outputs. The downconverters are in turn coupled to the demodulator bank 506, and in particular, individual demodulators such as the demodulator 510.

The switch may be, for example, a 5 input to 8 output switch. While only five downconverters and demodulators are illustrated, additional downconverters and demodulators may be added.

Preferably, the four beam phased array antenna 502 supports two communication channels (labeled Comm-1 and Comm-2), a spare channel (labeled Spare), and an acquisition channel (labeled ACQ). The ACQ channel provides the system acquisition function described above.

Thus, the present invention provides communication targets with dedicated, time shared, spot beams. Each communication target exercises independent control over the position of the spot beam, which may then follow with a mobile communication target to consistently provide communication bandwidth. The spot beams are generally narrow spot beams, thereby providing higher gain, faster burst bit rate, and much more efficient support for highly dispersed communication targets.

While the invention has been described with reference to a preferred embodiment, those skilled in the art will understand that various changes may be made and equivalents may be substituted without departing from the scope of the invention. In addition, many modifications may be made to adapt a particular step, structure, or material to the teachings of the invention without departing from its scope. Therefore, it is intended that the invention not be limited to the particular embodiment disclosed, but that the invention will include all embodiments falling within the scope of the appended claims.

What is claimed is:

1. A communication path processing system for a communication satellite comprising:
an electronically steered phased array antenna;
a position memory for storing communication target positions;
a processor coupled to the position memory, the processor operable to track communication targets by updating the communication target positions based on updated communication target positions received in an uplink; and
an antenna controller coupled to the antenna and to the processor for steering the antenna in accordance with the target positions.

2. A communication path processing system for a communication satellite comprising:
an electronically steered phased array antenna;
a position memory for storing communication target positions;
a processor coupled to the position memory, the processor operable to track communication targets by updating the communication target positions based on updated communication target positions received in an uplink; and
an antenna controller coupled to the antenna and to the processor for steering the antenna in accordance with the target positions;
the antenna generating beam spots assigned to individual communication targets, and the communication targets individually exercising control over assigned beam spots by generating the updated communication target positions.

3. A communication path processing system for a communication satellite comprising:
an electronically steered phased array antenna;
a position memory for storing communication target positions;
a processor coupled to the position memory, the processor operable to track communication targets by updating the communication target positions based on updated communication target positions received in an uplink; and
an antenna controller coupled to the antenna and to the processor for steering the antenna in accordance with the target positions;
the antenna generating beam spots assigned to individual communication targets, and the communication targets individually exercising control over assigned beam spots by generating updated communication target positions comprising latitude and longitude positions.

4. A communication path processing system for a communication satellite comprising:
an electronically steered phased array antenna;
a position memory for storing communication target positions;
a processor coupled to the position memory, the processor operable to track communication targets by updating the communication target positions based on updated communication target positions received in an uplink;
an antenna controller coupled to the antenna and to the processor for steering the antenna in accordance with the target positions; and
a predetermined time division multiplexed access schedule for updating communication targets;
the antenna generating beam spots assigned to individual communication targets, and the communication targets individually exercising control over assigned beam spots by generating updated communication target positions in accordance with the access schedule.

5. A method for providing communication bandwidth with a communication satellite, the method comprising:
reading communication target positions from a position memory;
steering an electronically steered antenna in accordance with the target positions;
receiving updated communication target positions in an uplink; and
tracking communication targets by updating the communication target positions based on updated communication target positions.

6. The method of claim 5, wherein receiving comprises receiving latitude and longitude positions.

7. A method for providing communication bandwidth with a communication satellite, the method comprising:
reading communication target positions from a position memory;
steering an electronically steered antenna in accordance with the target positions;
receiving updated communication target positions in an uplink; and
tracking communication targets by updating the communication target positions based on updated communication target positions and steering in according with a predetermined time division multiplexed access schedule for communication targets.

8. A communication system comprising:
a plurality of mobile cells, including a first cell assigned to a single first communication target and a second cell assigned to a single second communication target;
a position memory storing a first cell position determined by the first communication target and associated with the first cell and a second cell position determined by the second communication target and associated with the second cell;
an electronically steerable antenna for generating the first cell and the second cell; and
an antenna controller coupled to the antenna and the position memory, the antenna controller steering the antenna in accordance with a predetermined access schedule.

9. A communication system comprising:
a plurality of mobile cells, including a first cell assigned to a single first communication target and a second cell assigned to a single second communication target;
a position memory storing a first cell position determined by the first communication target and associated with the first cell and a second cell position determined by the second communication target and associated with the second cell;
an electronically steerable antenna for generating the first cell and the second cell; and
an antenna controller coupled to the antenna and the position memory, the antenna controller steering the antenna in accordance with a predetermined access schedule, the antenna controller being further responsive to an updated first cell position from the first communication target to steer the antenna to the updated first cell position, the updated first cell position replacing the first cell position in the position memory.

10. The communication system of claim 9, wherein the antenna controller is responsive to an updated second cell position from the second communication target to steer the antenna to the updated second cell position, the updated second cell position replacing the second cell position in the position memory.

11. The communication system of claim 9, wherein the predetermined access schedule is a time division multiplexed access schedule.
